(19) United States
(12) Patent Application Publication
(10) Pub. No.: US 2025/0355126 A1
(43) Pub. Date: Nov. 20, 2025

(54) DEVICE AND METHOD FOR WATER-PUMPING-INJECTION SINGLE-SPHERE NEUTRON SPECTRUM TIMING MEASUREMENT

(71) Applicant: Sichuan University of Science & Engineering, Zigong (CN)

(72) Inventors: Jianbo YANG, Zigong (CN); Jie XU, Zigong (CN); Rui LI, Zigong (CN); Rui SHI, Zigong (CN); Qibiao WANG, Zigong (CN); Honglong ZHENG, Zigong (CN); Kela XIAO, Zigong (CN)

(73) Assignee: Sichuan University of Science & Engineering, Zigong (CN)

(21) Appl. No.: 18/963,740

(22) Filed: Nov. 28, 2024

(30) Foreign Application Priority Data
May 20, 2024 (CN) 2024106252315

(51) Int. Cl. G01T 3/06; G01T 7/00

(52) U.S. Cl. CPC G01T 3/065; G01T 7/00

(57) ABSTRACT

Disclosed are a device and method for water-pumping-injection single-sphere neutron spectrum timing measurement. The device includes a double-layer nested shell, a central detector, a water pump, a water injector, a sprayer and a timing analysis system. The central detector is located at a center of an inner shell, and a single-layer moderation cavity for containing moderator liquid is formed between the inner shell and an outer shell. The sprayer, the water pump and the water injector cooperate to continuously adjust a water flow state and a mist sedimentation effect in the moderation cavity, and a moderator layer with a variable thickness is formed to meet measurement needs of different energy neutrons. The central detector is configured for detecting the thermal neutrons and the prompt gamma-ray signals. The device is compact and lightweight overall, and easy to transport and deploy on site, which facilitates promotion and application.

### CROSS-REFERENCE TO RELATED APPLICATIONS

The application claims priority to Chinese patent application No. CN2024106252315, filed on May 20, 2024, the entire contents of which are incorporated herein by reference.

### TECHNICAL FIELD

The present disclosure relates to the field of neutron spectrum measurement, and particularly relates to a device and method for water-pumping-injection single-sphere neutron spectrum timing measurement.

### BACKGROUND

Neutron spectrum measurement is of great significance to the fields of neutron radiation protection, nuclear safety, reactor design, and the like. Also, neutron spectrum measurement is a foundation for conducting neutron spectrum characteristic research and designing neutron radiation protection materials and devices. Multi-sphere neutron spectrometers have been widely used due to the advantages such as a wide energy measurement range, isotropy and simplicity.

In order to achieve an objective of portable multi-sphere neutron spectrum measurement, researchers have developed a variety of neutron spectrometers based on liquid moderators, such as a literature-recorded water-pumping-injection multi-layer concentric sphere device and a neutron spectrum detection system, and a fully automatic multi-sphere neutron spectrometer for water injection and drainage and a measurement method. In both of the literature, a plurality of shells that are sequentially sleeved from inside to outside are mentioned, where an innermost shell is sleeved on a surface of a neutron detector, gaps for accommodating liquid are formed between any two adjacent shells, and different moderation thicknesses are achieved by filling the gaps with a liquid moderator. Since water needs to be pumped and injected intermittently into the gaps between the multi-layer shells in a measurement process, the measurement takes a long time and rapid measurement of neutron spectra cannot be achieved. Moreover, separation of the pumping and injection operations from actual neutron measurements results in neutron information losses and inaccurate measurements in non-uniform fields. According to a literature-recorded small liquid-moderated neutron spectrum detector and a detection method, the detector has a structure of a water-pumping-injection device, and different thicknesses of moderators can be combined in one container by changing a moderator thickness of a small-volume moderation cavity, but a cylindrical structure of the detector is dependent on a direction of incident neutrons. According to a literature-recorded small sleeve neutron spectrum detector and a detection method, self-contained liquid is used as a moderator, and a thickness of moderator liquid is changed by changing air pressures of inner and outer cavities through a liquid level adjustment system, but a limited amount of self-contained liquid moderator restricts the detector's efficiency in moderating neutrons, and there also exists the problem of direction dependence.

Neutron spectrum measurement can also be realized through a neutron spectrometer based on prompt gamma neutron activation analysis. For example, according to a literature-recorded neutron spectrum measurement device and a measurement method, and a wide-energy neutron dose equivalent rate instrument based on a gamma-ray spectrum detector, prompt gamma rays generated by reaction of neutrons with various nuclides in the devices are detected by gamma detectors, and neutron spectra are analyzed based on energy and intensities of characteristic gamma rays. However, in order to obtain the prompt gamma rays of a plurality of various nuclides, a plurality of materials need to be stacked layer by layer, thereby resulting in inconvenience of transport due to a large mass.

### SUMMARY

An objective of the present disclosure is to provide a device for water-pumping-injection single-sphere neutron spectrum timing measurement, and the device, with water as a moderator, is capable of creating various combinations of moderators of different thicknesses in a single container and solving the problem of a large mass caused by stacking of a plurality of materials layer by layer, and is compact and lightweight overall.

The device for water-pumping-injection single-sphere neutron spectrum timing measurement in the technical solution includes a double-layer nested shell, a central detector, a water pump, a water injector, an exhauster, a sprayer and a timing analysis system, where
the double-layer nested shell includes an inner shell and an outer shell fixed together, the inner shell is tightly sleeved on a surface of the central detector, the outer shell surrounds the inner shell to form a single-layer moderation cavity for containing moderator liquid, and the moderator liquid has two states, i.e., water flow and mist spray;
the outer shell is provided with a top valve at a top and a bottom valve at a bottom; the water pump is connected to the bottom valve to extract liquid from the moderation cavity so as to adjust a content of the moderator liquid in the moderation cavity; the water injector is connected to the top valve to inject liquid into the moderation cavity so as to enhance liquid flow in the moderation cavity;
the sprayer connected to the top valve is arranged on an inner side of the top of the outer shell, and is configured for converting the moderator liquid injected from the water injector through the top valve into uniformly fine mist;
the exhauster is arranged on the top of the outer shell, and an exhaust pipe is inserted into the exhauster;
the central detector is configured for detecting thermal neutrons moderated by the moderator liquid and prompt characteristic gamma (γ) rays released from nuclear reactions between the neutrons and nuclides in the moderator liquid, and electrical pulse signals are formed; and
the timing analysis system is configured for controlling time of pumping and injecting the moderator liquid, pumping and injection rates, valve opening and closing time, and activation of the sprayer, and receiving and processing the neutrons and prompt gamma-ray signals of the central detector; the timing analysis system adjusts working states of the water pump, the water injector and the sprayer according to real-time feedback data; and after completing all data measurements, the timing analysis system outputs energy spectrum information of a measured neutron field after processing and calculation.

Further, the water pump is a pipe with one end connected to the moderation cavity through the bottom valve and open at the other end, and the water injector is a pipe with one end connected to the sprayer through the top valve and open at the other end.

Further, the outer shell and the inner shell are made of polyethylene, stainless steel, aluminum, or a mixture of polyethylene, stainless steel and aluminum; and thicknesses of the outer shell and the inner shell range from 1 mm to 5 mm.

Further, the sprayer includes a plurality of nozzles, the nozzles are evenly distributed on a top of the moderation cavity to ensure that the mist can be evenly distributed in the moderation cavity.

Further, the timing analysis system includes a timing control subsystem and a data acquisition and processing subsystem, where
the timing control subsystem includes a sensor, a controller and an actuator assembly, where the sensor is configured for monitoring and feeding back parameters of the moderation cavity such as a water level, a flow rate and a spray state in real time, the controller intelligently controls the water pumping, injection and exhaust, opening and closing of the sprayer, and durations to maintain continuous neutron measurement according to a preset timing program, and the actuator assembly is configured for responding to instructions issued by the controller, and performing fine adjustments over water injection and pumping rates and spray sizes, such that dynamic changes of the moderator are synchronized with the neutron measurement; and
the data acquisition and processing subsystem is electrically connected to the central detector, and is configured for receiving and processing the neutrons and the prompt gamma-ray signals of the central detector, and feeding back processed signal data to the timing control subsystem in real time; the timing control subsystem adjusts the working states of the water pump, the water injector and the sprayer according to the real-time feedback data; and after completing all data measurements, the data acquisition and processing subsystem outputs the energy spectrum information of the measured neutron field after processing and calculation.

Further, the central detector is a

$${Cs}_{2}^{6} {LiYCl}_{6}$$

scintillator detector or a NaI (Tl+Li) scintillator detector, or any other detector with both n and γ detection capabilities.

A second objective of the present disclosure is to provide a method for water-pumping-injection single-sphere neutron spectrum timing measurement, so as to synchronize the water-pumping-injection operation and the neutron measurement and minimize a neutron field interference.

The method for water-pumping-injection single-sphere neutron spectrum timing measurement includes the following steps:
S1, using a Monte Carlo method to simulate a n-γ response function matrix of the device for water-pumping-injection single-sphere neutron spectrum timing measurement in a water injection state and a water pumping state;
S2, placing the device for water-pumping-injection single-sphere neutron spectrum timing measurement in a detection area, keeping the moderation cavity free of the moderator liquid, allowing the neutrons to be incident on the central detector from a specific direction, and importing the n-γ response function matrix obtained in the S1;
S3, activating the timing analysis system to generate a series of first time sequences for controlling the operation of the water injector and the sprayer, where each of the first time sequences includes time information of each stage of a water injection cycle;
S4, at the first time sequence, synchronously starting the water injector and the sprayer to continuously inject the moderator liquid into the moderation cavity, capturing and recording the neutrons and prompt gamma-ray pulse signals through the central detector in real time, converting the pulse signals into digital signals through the data acquisition and processing subsystem, and transmitting the digital signals to the timing control subsystem in real time strictly according to the first time sequence;
S5, recording the neutrons with changing intensities during injection of the moderator liquid and the prompt gamma-ray pulse signals through the central detector, automatically recording, through the data acquisition and processing subsystem, a water injection rate, a sedimentation effect in the moderation cavity caused by spraying, and associated neutrons and prompt gamma-ray signals at each of the first time sequences, and flexibly adjusting the water injection rate of a water injector and a spray volume and uniformity of the sprayer according to data obtained by the timing control subsystem in real time;
S6, repeating the S4 and the S5 until a total duration of the first time sequences is reached or the moderation cavity reaches a predetermined moderator liquid filling content, and pausing the timing control subsystem in this case;
S7, generating a new second time sequence for controlling the operation of the water pump, starting the water pump at an initial moment of the second time sequence to start continuously extracting the moderator liquid in the moderation cavity, continuing to monitor and record, through the central detector, the neutrons and the prompt gamma-ray pulse signals, converting these signals into digital signals through the data acquisition and processing subsystem, transmitting them to the timing control subsystem according to the second time sequence, and dynamically adjusting a water pumping rate of the water pump through the timing control subsystem according to real-time feedback data to ensure smooth pumping and stable measurement of the moderator liquid in the moderation cavity;
S8, in a whole process of pumping, continuously recording, through the data acquisition and processing subsystem, the water pumping rate at each time node of the second time sequence and the corresponding neutrons and prompt gamma-ray signals;
S9, repeating the S7 and the S8 until a total duration of the second time sequence is reached or the moderator liquid in the moderation cavity is reduced to a preset threshold, and then shutting down the timing control subsystem; and
S10, adjusting time intervals of the first time sequences and the second time sequence, repeating the steps S1-S9 for a set number of times in a complete measurement cycle, analyzing, through the data acquisition and processing subsystem, the neutrons and prompt gamma-ray pulse signals in a water injection and pumping process with a set number of times, taking mean values of the set number of times after processing and calculation to form a matrix, and solving with the response function matrix in the S1, to output the energy spectrum information of the measured neutron field.

Further, a calculation process of the response function matrix in the S1 is as follows:
S1-1, calculating the moderator liquid content and the spray state corresponding to the moderation cavity in the water injection and pumping process according to a preset time sequence, and setting a volume corresponding to the moderator liquid content and a density of a material corresponding to the spray state in a Monte Carlo program;
S1-2, in a water injection stage, forming S₁ types of moderator thickness structures in the moderation cavity, where the corresponding neutrons and gamma-ray responses in each case are different; dividing a neutron energy interval into n energy groups within an energy range 10⁻⁹-20 MeV;
obtaining a water injection neutron response matrix

$${R}_{injection}^{n}$$

and a water injection gamma-ray response matrix

$${R}_{injection}^{y}$$

composed of S₁ rows and n columns respectively through Monte Carlo software simulation, where the two matrices are expressed as follows respectively:

$${R}_{injection}^{n} = [ \begin{matrix}{r}_{11}^{n} & {r}_{12}^{n} & {r}_{1 i}^{n} & {r}_{1 n}^{n} \\ {r}_{21}^{n} & & & \\ {r}_{k 1}^{n} & & {r}_{ki}^{n} & \\ {r}_{{S}_{1} 1}^{n} & & & {r}_{{S}_{1} n}^{n}\end{matrix} ] ;$$

$${R}_{injection}^{y} = [ \begin{matrix}{r}_{11}^{y} & {r}_{12}^{y} & {r}_{1 i}^{y} & {r}_{1 n}^{y} \\ {r}_{21}^{y} & & & \\ {r}_{k 1}^{y} & & {r}_{ki}^{y} & \\ {r}_{{S}_{1} 1}^{y} & & & {r}_{{S}_{1} n}^{y}\end{matrix} ] ;$$

S1-3, in a water pumping stage, forming S₂ types of moderator thickness structures in the moderation cavity, where the corresponding neutrons and gamma-ray responses in each case are different; dividing a neutron energy interval into n energy groups within an energy range of 10⁻⁹-20 MeV;
obtaining a water pumping neutron response matrix

$${R}_{pumping}^{n}$$

and a water pumping gamma-ray response matrix

$${R}_{pumping}^{y}$$

composed of S₂ rows and n columns respectively through the Monte Carlo software simulation, where the two matrices are expressed as follows respectively:

$${R}_{pumping}^{n} = [ \begin{matrix}{r}_{11}^{n} & {r}_{12}^{n} & {r}_{1 i}^{n} & {r}_{1 n}^{n} \\ {r}_{21}^{n} & & & \\ {r}_{k 1}^{n} & & {r}_{ki}^{n} & \\ {r}_{{S}_{2} 1}^{n} & & & {r}_{{S}_{2} n}^{n}\end{matrix} ] ;$$

$${R}_{pumping}^{y} = [ \begin{matrix}{r}_{11}^{y} & {r}_{12}^{y} & {r}_{1 i}^{y} & {r}_{1 n}^{y} \\ {r}_{21}^{y} & & & \\ {r}_{k 1}^{y} & & {r}_{ki}^{y} & \\ {r}_{{S}_{2} 1}^{y} & & & {r}_{{S}_{2} n}^{y}\end{matrix} ] ;$$

S1-4, finally forming a water-pumping-injection single-sphere n-γ response function matrix R, which is expressed as follows:

$$R = {[ \begin{matrix}{R}_{injection}^{n} & {R}_{pumping}^{n} & {R}_{injection}^{y} & {R}_{pumping}^{y}\end{matrix} ]}^{T} .$$

Further, a specific process of the S4 is as follows:
S4-1, closing the bottom valve, opening the top valve and the sprayer, continuously injecting the moderator liquid into a water injection pipe, converting the liquid into the uniformly fine mist through the sprayer, and spraying evenly inside the moderation cavity through the nozzles to form a uniformly distributed mist sedimentation effect;
S4-2, at a first time node of the set first time sequence, outputting, through the central detector, the neutrons and prompt gamma-ray pulse signals measured for the first time, converting, through the data acquisition and processing subsystem, the pulse signals into digital signals, and calculating a count value N₁ of the digital signals measured for the first time; and
S4-3, according to a preset time interval of the first time sequences, continuously recording, through the central detector, pulse signals at each of time nodes 2-S₁ in sequence, converting the pulse signals into digital signals one by one correspondingly through the data acquisition and processing subsystem, and sequentially calculating count values N₁-NS₁ of the digital signals corresponding to the respective time nodes.

Further, a specific process of the S7 is as follows:
S7-1, closing the top valve and the sprayer, opening the bottom valve, and continuously pumping out the moderator liquid in the moderation cavity from a water pumping pipe;

S7-2, at a first time node of the set second time sequence, outputting, through the central detector, prompt gamma-ray pulse signals measured for the first time, converting, through the data acquisition and processing subsystem, the pulse signals into digital signals, and calculating a count value M₁ of the digital signals measured for the first time; and
S7-3, according to a preset time interval of the second time sequence, continuously recording, through the central detector, pulse signals at each of time nodes 2-S₂ in sequence, converting the pulse signals into digital signals one by one correspondingly through the data acquisition and processing subsystem, and sequentially calculating count values M₁-MS₂ of the digital signals corresponding to the respective time nodes.

Compared with the prior art, the technical solution has the beneficial effects as follows:

(1) A neutron spectrometer detection method in the prior art that requires use of a plurality of “physical moderator spheres” is changed. By adjusting a liquid state of the single-sphere moderation cavity (the mist sedimentation effect and water flow change), a variety of moderation combinations are formed. The device has an overall simple structure, few components, and a low weight.

(2) The timing control subsystem achieves synchronization of the water-pumping-injection operation with the neutron measurement, and significantly improves measurement efficiency. Synchronous measurement reduces a loss of neutron information caused by operation delay, ensures measurement continuity and completeness, and has minimal disturbance to the neutron field to be measured, making it suitable for scenarios requiring rapid measurement.

(3) Incident neutron information can be obtained only according to response differences of neutrons under different moderation conditions, or by use of the prompt characteristic gamma rays released from the nuclear reactions between the thermal neutrons and the nuclides in the moderator liquid, or by combining the above two methods, that is, the neutron spectrum measurement can be realized based on one device and a plurality of methods.

(4) The device of a spherical structure makes a consistent response to the neutrons incident from different directions, thereby avoiding measurement deviations caused by directionality and improving accuracy of measurement results.

(5) The device of a single moderation sphere structure is compact and lightweight, and easy to carry and deploy on site, and can be used for the neutron spectrum measurement in narrow spaces or at special locations.

(6) The device with raw materials easily obtained is simple to process, which greatly reduces difficulty and costs of manufacturing and maintenance, and facilitates technology promotion and application.

### BRIEF DESCRIPTION OF DRAWINGS

FIG. 1 is a front view of a water injection structure of a device for water-pumping-injection single-sphere neutron spectrum timing measurement in Example 1 of the present disclosure.

FIG. 2 is a front view of a water pumping structure (different water volumes) of the device for water-pumping-injection single-sphere neutron spectrum timing measurement in Example 1 of the present disclosure.

FIG. 3 illustrates an n-γ response function matrix of water-pumping-injection single-sphere neutron spectrum timing measurement in Example 3 of the present disclosure.

### DETAILED DESCRIPTION OF THE EMBODIMENTS

The present disclosure will be further described in detail below by means of specific embodiments.

Reference numerals in the figures of the specification include: central detector 1, double-layer nested shell 2, water injector 3, water pump 4, exhauster 5, water flow state moderator liquid 6, mist spray state moderator liquid 7, sprayer 8, and moderation cavity 9.

### Example 1

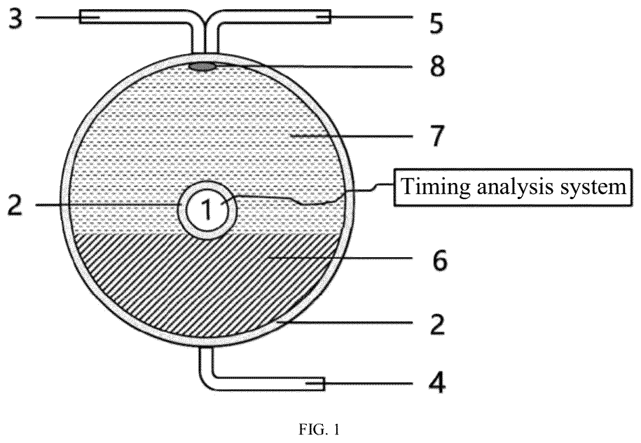

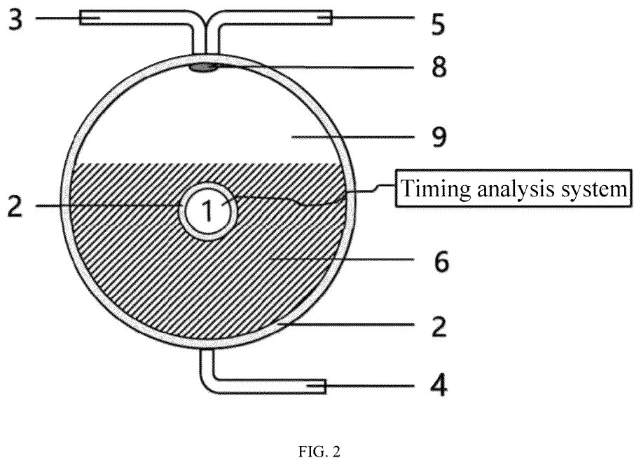

A device for water-pumping-injection single-sphere neutron spectrum timing measurement, as illustrated in FIGS. 1 and 2, includes a double-layer nested shell 2, a central detector 1, a water pump 4, a water injector 3, an exhauster 5, a sprayer 8 and a timing analysis system, where
the double-layer nested shell 2 includes an inner shell and an outer shell fixed together, the inner shell is tightly sleeved on a surface of the central detector 1, a gap between the inner shell and the central detector 1 is less than 1 mm, the outer shell surrounds the inner shell to form a single-layer moderation cavity 9, the moderation cavity 9 is configured for containing moderator liquid, and the moderator liquid includes water flow state moderator liquid 6 and mist spray state moderator liquid 7. The moderator liquid can be any liquid with good moderation performance, such as water, heavy water, a boron-containing solution, a lithium-containing solution or liquid grease. Preferably, the moderator liquid is water, which is cost-effective and easily available.

The outer shell and the inner shell are made of polyethylene, stainless steel, aluminum, or a mixture of polyethylene, stainless steel and aluminum; and for example, the double-layer nested shell 2 can be made of aluminum, including pure aluminum or aluminum alloy, without limitation thereto in this example. Aluminum has a low density, and the relatively thin double-layer nested shell 2 made of aluminum is significantly lighter than that made of stainless steel. Thicknesses of the outer shell and the inner shell range from 1 mm to 5 mm. In this example, an optimal thickness is set as 2 mm to ensure measurement performance and structural stability.

The outer shell is provided with a top valve at a top and a bottom valve at a bottom, and the top valve and bottom valve are selected from products in the prior art according to actual needs. The water pump 4 is connected to the bottom valve, the water pump 4 is configured for extracting liquid from the moderation cavity 9 so as to adjust a content of the moderator liquid in the moderation cavity 9; the water injector 3 is connected to the top valve, and the water injector 3 is configured for injecting liquid into the moderation cavity 9 so as to enhance liquid flow in the moderation cavity 9. The water pump 4 is a pipe with one end connected to the moderation cavity 9 through the bottom valve and open at the other end, and the water injector 3 is a pipe with one end connected to the sprayer 8 through the top valve and open at the other end.

The sprayer 8 connected to the top valve is mounted on an inner side of a top of the outer shell, the sprayer 8 is configured for converting the moderator liquid injected from the water injector 3 through the top valve into uniformly fine mist, and the sprayer 8 can be of a spray structure in the prior art, so details are not described herein again. The sprayer 8 includes a plurality of nozzles, the number of the nozzles is set according to actual needs, and the nozzles are evenly distributed on a top of the moderation cavity 9 to ensure that the mist can be evenly distributed in the moderation cavity 9.

The exhauster 5 is arranged on the top of the outer shell, and an exhaust pipe is inserted into the exhauster 5.

The central detector 1 is configured for detecting thermal neutrons moderated by the moderator liquid and prompt characteristic gamma (γ) rays released from nuclear reactions between the neutrons and nuclides in the moderator liquid, and electrical pulse signals are formed. The central detector 1 is a Cs₂⁶LiYCl₆ scintillator detector or a NaI (Tl+Li) scintillator detector, or any other detector with both n and γ detection capabilities.

The timing analysis system is configured for controlling time of pumping and injecting the moderator liquid, pumping and injection rates, valve opening and closing time, and activation of the sprayer 8, acquiring a count value output by a signal acquisition unit each time to form a count value matrix, and solving with a pre-stored response function matrix to obtain a neutron spectrum.

The timing analysis system includes a timing control subsystem and a data acquisition and processing subsystem, where the timing control subsystem includes a sensor, a controller and an actuator assembly: the sensor is configured for monitoring and feeding back parameters of the moderation cavity such as a water level, a flow rate and a spray state in real time, and the sensor can be selected from sensor products in the prior art; the controller intelligently controls the water pumping, injection and exhaust, opening and closing of the sprayer 8, and durations to maintain continuous neutron measurement according to a preset timing program, and the controller can be selected from STM single-chip microcomputer chips in the prior art; and the actuator assembly is configured for responding to instructions issued by the controller, and performing fine adjustments over water injection and pumping rates and spray sizes, such that dynamic changes of the moderator are synchronized with the neutron measurement, thereby ensuring the synchronization of the dynamic changes of the moderator with the neutron measurement.

The data acquisition and processing subsystem is electrically connected to the central detector 1, and is configured for receiving and processing the neutrons and the prompt gamma-ray signals of the central detector, and feeding back processed signal data to the timing control subsystem in real time; the timing control subsystem adjusts the working states of the water pump 4, the water injector 3 and the sprayer 8 according to the real-time feedback data; and after completing all data measurements, the data acquisition and processing subsystem outputs the energy spectrum information of the measured neutron field after processing and calculation.

The device in Example 1 has the following advantages compared with other devices in the prior art:
(1) The timing control subsystem achieves synchronization of the water-pumping-injection operation with the neutron measurement, and significantly improves measurement efficiency. Synchronous measurement reduces a loss of neutron information caused by operation delay, ensures measurement continuity and completeness, and has minimal disturbance to the neutron field to be measured, making it suitable for scenarios requiring rapid measurement.
(2) The device for water-pumping-injection single-sphere neutron spectrum timing measurement is capable of analyzing incident neutron information only according to response differences of neutrons under different moderation conditions; prompt characteristic gamma rays can be obtained also based on the nuclear reactions between the thermal neutrons and the moderator liquid in the moderation cavity 9, and intensities and energy of the characteristic gamma rays can be further analyzed to obtain the incident neutron information, such as the number and energy distribution of the incident neutrons; and furthermore, the above two methods can be combined to obtain the incident neutron information, and neutron spectrum measurement can be achieved with a device by means of three methods.
(3) The device of a spherical structure makes a consistent response to the neutrons incident from different directions, thereby avoiding measurement deviations caused by directionality and improving accuracy of measurement results.

### Example 2

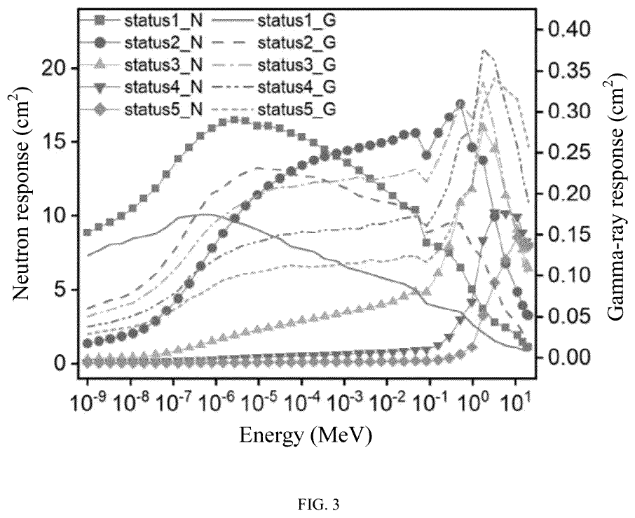

Based on the device in Example 1, a method for water-pumping-injection single-sphere neutron spectrum timing measurement is provided, and as shown in FIG. 3, includes the following steps:
S1, a Monte Carlo method is used to simulate a n-γ response function matrix of the device for water-pumping-injection single-sphere neutron spectrum timing measurement in a water injection state and a water pumping state, and a specific simulation process is as follows:
S1-1, the moderator liquid content and the spray state corresponding to the moderation cavity 9 in the water injection and pumping process are calculated according to a preset time sequence, and a volume corresponding to the moderator liquid content and a density of a material corresponding to the spray state are set in a Monte Carlo program;
S1-2, in a water injection stage, S₁ types of moderator thickness structures are formed in the moderation cavity 9, where the corresponding neutrons and gamma-ray responses in each case are different; a neutron energy interval is divided into n energy groups within an energy range of 10⁻⁹-20 MeV;
a water injection neutron response matrix

$${R}_{injection}^{n}$$

and a water injection gamma-ray response matrix

$${R}_{injection}^{y}$$

composed of S₁ rows and n columns are obtained respectively through Monte Carlo software simulation, where the two matrices are expressed as follows respectively:

$${R}_{injection}^{n} = [ \begin{matrix}{r}_{11}^{n} & {r}_{12}^{n} & {r}_{1 i}^{n} & {r}_{1 n}^{n} \\ {r}_{21}^{n} & & & \\ {r}_{k 1}^{n} & & {r}_{ki}^{n} & \\ {r}_{{S}_{1} 1}^{n} & & & {r}_{{S}_{1} n}^{n}\end{matrix} ] ;$$

$${R}_{injection}^{y} = [ \begin{matrix}{r}_{11}^{y} & {r}_{12}^{y} & {r}_{1 i}^{y} & {r}_{1 n}^{y} \\ {r}_{21}^{y} & & & \\ {r}_{k 1}^{y} & & {r}_{ki}^{y} & \\ {r}_{{S}_{1} 1}^{y} & & & {r}_{{S}_{1} n}^{y}\end{matrix} ] ;$$

S1-3, in a water pumping stage, S₂ types of moderator thickness structures are formed in the moderation cavity 9, where the corresponding neutrons and gamma-ray responses in each case are different; dividing a neutron energy interval into n energy groups within an energy range of 10⁻⁹-20 MeV;
a water pumping neutron response matrix

$${R}_{pumping}^{n}$$

and a water pumping gamma-ray response matrix

$${R}_{pumping}^{γ}$$

composed of S₂ rows and n columns are obtained respectively through the Monte Carlo software simulation, where the two matrices are expressed as follows respectively:

$${R}_{pumping}^{n} = [ \begin{matrix}{r}_{11}^{n} & {r}_{12}^{n} & {r}_{1 i}^{n} & {r}_{1 n}^{n} \\ {r}_{21}^{n} & & & \\ {r}_{k 1}^{n} & & {r}_{ki}^{n} & \\ {r}_{{S}_{2} 1}^{n} & & & {r}_{{S}_{2} n}^{n}\end{matrix} ] ; \\ {R}_{pumping}^{γ} = [ \begin{matrix}{r}_{11}^{γ} & {r}_{12}^{γ} & {r}_{1 i}^{γ} & {r}_{1 n}^{γ} \\ {r}_{21}^{γ} & & & \\ {r}_{k 1}^{γ} & & {r}_{ki}^{γ} & \\ {r}_{{S}_{2} 1}^{γ} & & & {r}_{{S}_{2} n}^{γ}\end{matrix} ] ;$$

S1-4, a water-pumping-injection single-sphere n-γ response function matrix R is finally formed, which is expressed as follows:

$$R = {[ \begin{matrix}{R}_{injection}^{n} & {R}_{pumping}^{n} & {R}_{injection}^{γ} & {R}_{pumping}^{γ}\end{matrix} ]}^{T} .$$

S2, the device for water-pumping-injection single-sphere neutron spectrum timing measurement is placed in a detection area, the moderation cavity 9 is kept free of the moderator liquid, the neutrons are allowed to be incident on the central detector 1 from a specific direction, and the n-γ response function matrix obtained in the S1 is imported;
S3, a series of first time sequences for controlling the operation of the water injector 3 and the sprayer 8 are generated, where each of the first time sequences includes time information of each stage of a water injection cycle;
S4, at the first time sequence, the water injector 3 and the sprayer 8 are synchronously started to continuously inject the moderator liquid into the moderation cavity 9, the neutrons and prompt gamma-ray pulse signals are captured and recorded through the central detector 1 in real time, the pulse signals are converted into digital signals through the data acquisition and processing subsystem, and the digital signals are transmitted to the timing control subsystem in real time strictly according to the first time sequence; detailed sub-steps specifically include:
S4-1, the bottom valve is closed, the top valve and the sprayer 8 are opened, the moderator liquid is continuously injected into a water injection pipe, the liquid is converted into the uniformly fine mist through the sprayer 8 by means of fine atomization, and spraying evenly inside the moderation cavity 9 is performed through the nozzles to form a uniformly distributed mist sedimentation effect;
the fine atomization includes: the bottom valve is closed, the top valve and the sprayer 8 are opened, the moderator liquid is continuously injected into a water injection pipe, the sprayer 8 atomizes the moderator liquid into the uniformly fine mist with a particle size ranging from 50 μm to 100 μm, and the atomized moderator liquid is evenly distributed in the moderation cavity 9 through the nozzles to form a uniformly distributed mist sedimentation effect;
S4-2, at a first time node of the set first time sequence, the neutrons and prompt gamma-ray pulse signals measured for the first time are output through the central detector 1, the pulse signals are converted into digital signals through the data acquisition and processing subsystem, and a count value N₁ of the digital signals measured for the first time is calculated; and
S4-3, according to a preset time interval of the first time sequences, pulse signals at each of time nodes 2-S₁ in sequence are continuously recorded through the central detector 1, the pulse signals are converted into digital signals one by one correspondingly through the data acquisition and processing subsystem, and count values N₁-NS₁ of the digital signals corresponding to the respective time nodes are sequentially calculated.
S5, the neutrons with changing intensities during injection of the moderator liquid and the prompt gamma-ray pulse signals are recorded through the central detector 1, a water injection rate, a sedimentation effect in the moderation cavity 9 caused by spraying, and associated neutrons and prompt gamma-ray signals at each of the first time sequences are automatically recorded through the data acquisition and processing subsystem, and the water injection rate of a water injector and a spray volume and uniformity of the sprayer 8 are flexibly adjusted according to data obtained by the timing control subsystem in real time;

During the flexible adjustment, when the central detector 1 detects that a pulse signal intensity of the neutrons and gamma rays suddenly increases, which indicates an excessive moderation capacity, the timing control subsystem instructs the water injector 3 to reduce the water injection rate and decrease the spray volume and frequency of the sprayer 8 to weaken a moderation effect. When an area in the moderation cavity 9 shows excessively high neutron flux, the timing control subsystem instructs the sprayer 8 to adjust a spray mode, including changing a nozzle direction or increasing a distribution density of spray points, so as to achieve a more uniform moderation effect.
S6, the S4 and the S5 are repeated until a total duration of the first time sequences is reached or the moderation cavity 9 reaches a predetermined moderator liquid filling content, and the timing control subsystem is paused in this case;
S7, a new second time sequence for controlling the operation of the water pump 4 is generated, the water pump 4 is started at an initial moment of the second time sequence to start continuously extracting the moderator liquid in the moderation cavity 9, the neutrons and the prompt gamma-ray pulse signals are further monitored and recorded through the central detector 1, these signals are converted into digital signals through the data acquisition and processing subsystem, the digital signals are transmitted to the timing control subsystem according to the second time sequence, and a water pumping rate of the water pump 4 is dynamically adjusted through the timing control subsystem according to real-time feedback data to ensure smooth pumping and stable measurement of the moderator liquid in the moderation cavity 9;
S7-1, the top valve and the sprayer are closed, the bottom valve is opened, and the moderator liquid in the moderation cavity 9 is continuously pumped from a water pumping pipe;
S7-2, at a first time node of the set second time sequence, prompt gamma-ray pulse signals measured for the first time are output through the central detector, the pulse signals are converted into digital signals through the data acquisition and processing subsystem, and a count value M₁ of the digital signals measured for the first time is calculated; and
S7-3, according to a preset time interval of the second time sequence, pulse signals at each of time nodes 2-S₂ in sequence are continuously recorded through the central detector 1, the pulse signals are converted into digital signals one by one correspondingly through the data acquisition and processing subsystem, and count values M₁-MS₂ of the digital signals corresponding to the respective time nodes are sequentially calculated.
S8, in a whole process of pumping, the water pumping rate at each time node of the second time sequence and the corresponding neutrons and prompt gamma-ray signals are continuously recorded through the data acquisition and processing subsystem;
S9, the S7 and the S8 are repeated until a total duration of the second time sequence is reached or the moderator liquid in the moderation cavity 9 is reduced to a preset threshold, and then the timing control subsystem is shut down; and
S10, time intervals of the first time sequences and the second time sequence are adjusted, the steps S1-S9 are repeated for a set number of times in a complete measurement cycle, the neutrons and prompt gamma-ray pulse signals in a water injection and pumping process with a set number of times are analyzed through the data acquisition and processing subsystem, mean values of the set number of times are taken after processing and calculation to form a matrix, and solving with the response function matrix in the S1 is performed to output the energy spectrum information of the measured neutron field. A solution process of the energy spectrum information is as follows:

S10-1, a data acquisition processing subsystem combines count values of S₁+S₂ thermal neutrons and prompt gamma (γ) rays to form a count matrix composed of one row and 2×(S₁+S₂) columns, and the matrix is expressed as follows:

$${[ \begin{matrix}{C}_{1}^{n} & … & {C}_{{m}_{1}}^{n} & … & {C}_{{S}_{1} + {S}_{2}}^{n} & {C}_{1}^{γ} & … & {C}_{{m}_{1}}^{γ} & … & {C}_{{S}_{1} + {S}_{2}}^{γ}\end{matrix} ]}^{T} ;$$

S10-2, calculation is performed according to a calculation formula of neutron spectra:

$${C}_{k} = {\int }_{{E}_{m i n}}^{{E}_{ma x}} {R}_{k} ( E ) Φ ( E ) dE ;$$

where Cₖ is a count of the detector, Rₖ is a response function of the detector at energy E, and Φ (E) is incident neutron spectrum flux with the energy E;
S10-3, the formula in the S10-2 is discretized to obtain:

$${C}_{k} = {\sum }_{l = 1}^{n} {R}_{ki} {φ}_{i} ;$$

the count matrix in the S10-1 and the response function matrix in the S1-4 are substituted into the S10-3 to obtain:

$$[ \begin{matrix}{r}_{11}^{n} & {r}_{12}^{n} & ⋯ & {r}_{1 i}^{n} & ⋯ & {r}_{1 n}^{n} \\ {r}_{k 1}^{n} & & & & & \\ {r}_{{S}_{1} + {S}_{2} , 1}^{n} & & & {r}_{{S}_{1} + {S}_{2} , 1}^{n} & & {r}_{{S}_{1} + {S}_{2} , n}^{n} \\ {r}_{11}^{γ} & & & & & \\ {r}_{k 1}^{γ} & & & {r}_{ki}^{γ} & & \\ {r}_{{S}_{1} + {S}_{2} , 1}^{γ} & & & & & {r}_{{S}_{1} + {S}_{2} , n}^{γ}\end{matrix} ] [ \begin{matrix}{φ}_{1} \\ {φ}_{2} \\ ⋮ \\ {φ}_{i} \\ ⋮ \\ {φ}_{n}\end{matrix} ] = [ \begin{matrix}{C}_{1}^{n} \\ {C}_{{k}_{1}}^{n} \\ {C}_{{S}_{1} + {S}_{2}}^{n} \\ {C}_{1}^{γ} \\ {C}_{{k}_{1}}^{γ} \\ {C}_{{S}_{1} + {S}_{2}}^{γ}\end{matrix} ] ;$$

[φ₁ φ₂ . . . φᵢ . . . φₙ]^{T} is the neutron spectrum of an area to be measured.

In Example 2, the central detector 1 is configured for detecting the thermal neutrons and the prompt gamma-ray signals generated by reactions of the thermal neutrons with moderator nuclides through the measurement method, which achieves neutron spectrum measurement and significantly improves system detection efficiency. Pumping and injection operations are involved in the neutron spectrum measurement in real time, which helps to minimize a neutron field interference. The device is compact and lightweight overall, and easy to transport and deploy on site, which facilitates promotion and application.

### Example 3

On the basis of Example 1 and Example 2, a determined device and a determined measurement method are used for verification and explanation. In the device for water-pumping-injection single-sphere neutron spectrum timing measurement, an outer spherical shell of the double-layer nested shell 2 is an aluminum shell with a radius of 22.8 cm and a wall thickness of 2 mm, an inner layer thereof is a cylindrical aluminum shell with a height of 9 cm, a radius of 3 cm and a thickness of 2 mm, and the central detector 1 is a cylindrical CLYC scintillator detector with a radius of 2.54 cm and a height of 10.16 cm. The rest are the same as those in Example 1.

A Monte Carlo simulation program is used to simulate the water injection response function matrix R corresponding to five types of the mist spray state moderator liquid 7, as shown in FIG. 3. According to five count values of the neutrons and the prompt gamma rays and the water injection response function matrix R, the data acquisition and processing subsystem calculates the neutron spectrum to be measured through a neutron spectrum unfolding algorithm. After the measurement, the mist spray state moderator liquid 7 is discharged to the outside through a pipeline connected to the water pump 4.

What are described above are merely examples of the present disclosure, and common general knowledge such as well-known specific structures and characteristics in the solutions is not described too much herein. It should be noted that those skilled in the art may further make several transformations and improvements on the premise of not deviating from the structure of the present disclosure, and these transformations and improvements should fall within the scope of protection of the present disclosure without affecting the implementation effect of the present disclosure and the practicability of the patent. The protection scope of the present disclosure shall be determined by the terms of the claims, and the specific embodiments and other records in the specification can be used to interpret the content of the claims.

What is claimed is:

1. A device for water-pumping-injection single-sphere neutron spectrum timing measurement, comprising a double-layer nested shell, a central detector, a water pump, a water injector, an exhauster, a sprayer and a timing analysis system, wherein
the double-layer nested shell comprises an inner shell and an outer shell fixed together, the inner shell is tightly sleeved on a surface of the central detector, the outer shell surrounds the inner shell to form a single-layer moderation cavity for containing moderator liquid, and the moderator liquid has two states, i.e., water flow and mist spray;
the outer shell is provided with a top valve at a top and a bottom valve at a bottom; the water pump is connected to the bottom valve to extract liquid from the moderation cavity so as to adjust a content of the moderator liquid in the moderation cavity; the water injector is connected to the top valve to inject liquid into the moderation cavity so as to enhance liquid flow in the moderation cavity;
the sprayer connected to the top valve is arranged on an inner side of the top of the outer shell, and is configured for converting the moderator liquid injected from the water injector through the top valve into uniformly fine mist;
the exhauster is arranged on the top of the outer shell, and an exhaust pipe is inserted into the exhauster;
the central detector is configured for detecting thermal neutrons moderated by the moderator liquid and prompt characteristic gamma (γ) rays released from nuclear reactions between the neutrons and nuclides in the moderator liquid, and electrical pulse signals are formed; and
the timing analysis system is configured for controlling time of pumping and injecting the moderator liquid, pumping and injection rates, valve opening and closing time, and activation of the sprayer, and receiving and processing the neutrons and prompt gamma-ray signals of the central detector; the timing analysis system adjusts working states of the water pump, the water injector and the sprayer according to real-time feedback data; and after completing all data measurements, the timing analysis system outputs energy spectrum information of a measured neutron field after processing and calculation.

2. The device for water-pumping-injection single-sphere neutron spectrum timing measurement according to claim 1, wherein the water pump is a pipe with one end connected to the moderation cavity through the bottom valve and open at the other end, and the water injector is a pipe with one end connected to the sprayer through the top valve and open at the other end.

3. The device for water-pumping-injection single-sphere neutron spectrum timing measurement according to claim 2, wherein the outer shell and the inner shell are made of polyethylene, stainless steel, aluminum, or a mixture of polyethylene, stainless steel and aluminum; and thicknesses of the outer shell and the inner shell range from 1 mm to 5 mm.

4. The device for water-pumping-injection single-sphere neutron spectrum timing measurement according to claim 3, wherein the sprayer comprises a plurality of nozzles, the nozzles are evenly distributed on a top of the moderation cavity to ensure that the mist can be evenly distributed in the moderation cavity.

5. The device for water-pumping-injection single-sphere neutron spectrum timing measurement according to claim 4, wherein the timing analysis system comprises a timing control subsystem and a data acquisition and processing subsystem, wherein
the timing control subsystem comprises a sensor, a controller and an actuator assembly, wherein the sensor is configured for monitoring and feeding back parameters of the moderation cavity such as a water level, a flow rate and a spray state in real time, the controller intelligently controls the water pumping, injection and exhaust, opening and closing of the sprayer, and durations to maintain continuous neutron measurement according to a preset timing program, and the actuator assembly is configured for responding to instructions issued by the controller, and performing fine adjustments over water injection and pumping rates and spray sizes, such that dynamic changes of the moderator are synchronized with the neutron measurement; and
the data acquisition and processing subsystem is electrically connected to the central detector, and is configured for receiving and processing the neutrons and the prompt gamma-ray signals of the central detector, and feeding back processed signal data to the timing control subsystem in real time; the timing control subsystem adjusts the working states of the water pump, the water injector and the sprayer according to the real-time feedback data; and after completing all data measurements, the data acquisition and processing subsystem outputs the energy spectrum information of the measured neutron field after processing and calculation.

6. The device for water-pumping-injection single-sphere neutron spectrum timing measurement according to claim 5, wherein the central detector is a Cs₂⁶LiYCl₆ scintillator detector or a NaI (Tl+Li) scintillator detector, or any other detector with both n and γ detection capabilities.

7. A method for water-pumping-injection single-sphere neutron spectrum timing measurement, comprising the following steps:
S1, using a Monte Carlo method to simulate a n-γ response function matrix of the device for water-pumping-injection single-sphere neutron spectrum timing measurement in a water injection state and a water pumping state;
S2, placing the device for water-pumping-injection single-sphere neutron spectrum timing measurement in a detection area, keeping the moderation cavity free of the moderator liquid, allowing the neutrons to be incident on the central detector from a specific direction, and importing the n-γ response function matrix obtained in the S1;
S3, activating the timing analysis system to generate a series of first time sequences for controlling the operation of the water injector and the sprayer, wherein each of the first time sequences includes time information of each stage of a water injection cycle;
S4, at the first time sequence, synchronously starting the water injector and the sprayer to continuously inject the moderator liquid into the moderation cavity, capturing and recording the neutrons and prompt gamma-ray pulse signals through the central detector in real time, converting the pulse signals into digital signals through the data acquisition and processing subsystem, and transmitting the digital signals to the timing control subsystem in real time strictly according to the first time sequence;
S5, recording the neutrons with changing intensities during injection of the moderator liquid and the prompt gamma-ray pulse signals through the central detector, automatically recording, through the data acquisition and processing subsystem, a water injection rate, a sedimentation effect in the moderation cavity caused by spraying, and associated neutrons and prompt gamma-ray signals at each of the first time sequences, and flexibly adjusting the water injection rate of a water injector and a spray volume and uniformity of the sprayer according to data obtained by the timing control subsystem in real time;
S6, repeating the S4 and the S5 until a total duration of the first time sequences is reached or the moderation cavity reaches a predetermined moderator liquid filling content, and pausing the timing control subsystem in this case;
S7, generating a new second time sequence for controlling the operation of the water pump, starting the water pump at an initial moment of the second time sequence to start continuously extracting the moderator liquid in the moderation cavity, continuing to monitor and record, through the central detector, the neutrons and the prompt gamma-ray pulse signals, converting these signals into digital signals through the data acquisition and processing subsystem, transmitting them to the timing control subsystem according to the second time sequence, and dynamically adjusting a water pumping rate of the water pump through the timing control subsystem according to real-time feedback data to ensure smooth pumping and stable measurement of the moderator liquid in the moderation cavity;
S8, in a whole process of pumping, continuously recording, through the data acquisition and processing subsystem, the water pumping rate at each time node of the second time sequence and the corresponding neutrons and prompt gamma-ray signals;
S9, repeating the S7 and the S8 until a total duration of the second time sequence is reached or the moderator liquid in the moderation cavity is reduced to a preset threshold, and then shutting down the timing control subsystem; and
S10, adjusting time intervals of the first time sequences and the second time sequence, repeating the steps S1-S9 for a set number of times in a complete measurement cycle, analyzing, through the data acquisition and processing subsystem, the neutrons and prompt gamma-ray pulse signals in a water injection and pumping process with a set number of times, taking mean values of the set number of times after processing and calculation to form a matrix, and solving with the response function matrix in the S1, to output the energy spectrum information of the measured neutron field.

8. The method for water-pumping-injection single-sphere neutron spectrum timing measurement according to claim 7, wherein a calculation process of the response function matrix in the S1 is as follows:
S1-1, calculating the moderator liquid content and the spray state corresponding to the moderation cavity in the water injection and pumping process according to a preset time sequence, and setting a volume corresponding to the moderator liquid content and a density of a material corresponding to the spray state in a Monte Carlo program;
S1-2, in a water injection stage, forming S₁ types of moderator thickness structures in the moderation cavity, wherein the corresponding neutrons and gamma-ray responses in each case are different; dividing a neutron energy interval into n energy groups within an energy range of 10⁻⁹-20 MeV;
obtaining a water injection neutron response matrix
$${R}_{injection}^{n}$$
and a water injection gamma-ray response matrix
$${R}_{injection}^{γ}$$
composed of S₁ rows and n columns respectively through Monte Carlo software simulation, wherein the two matrices are expressed as follows respectively:
$${R}_{injection}^{n} = [ \begin{matrix}{r}_{11}^{n} & {r}_{12}^{n} & {r}_{1 i}^{n} & {r}_{1 n}^{n} \\ {r}_{21}^{n} & & & \\ {r}_{k 1}^{n} & & {r}_{ki}^{n} & \\ {r}_{{S}_{2} 1}^{n} & & & {r}_{{S}_{1} n}^{n}\end{matrix} ] ; \\ {R}_{injection}^{γ} = [ \begin{matrix}{r}_{11}^{γ} & {r}_{12}^{γ} & {r}_{1 i}^{γ} & {r}_{1 n}^{γ} \\ {r}_{21}^{γ} & & & \\ {r}_{k 1}^{γ} & & {r}_{ki}^{γ} & \\ {r}_{{S}_{1} 1}^{γ} & & & {r}_{{S}_{1} n}^{γ}\end{matrix} ] ;$$
S1-3, in a water pumping stage, forming S₂ types of moderator thickness structures in the moderation cavity, wherein the corresponding neutrons and gamma-ray responses in each case are different; dividing a neutron energy interval into n energy groups within an energy range of 10⁻⁹-20 MeV;
obtaining a water pumping neutron response matrix
$${R}_{pumping}^{n}$$
and a water pumping gamma-ray response matrix
$${R}_{pumping}^{γ}$$
composed of S₂ rows and n columns respectively through the Monte Carlo software simulation, wherein the two matrices are expressed as follows respectively:
$${R}_{pumping}^{n} = [ \begin{matrix}{r}_{11}^{n} & {r}_{12}^{n} & {r}_{1 i}^{n} & {r}_{1 n}^{n} \\ {r}_{21}^{n} & & & \\ {r}_{k 1}^{n} & & {r}_{ki}^{n} & \\ {r}_{{S}_{2} 1}^{n} & & & {r}_{{S}_{2} n}^{n}\end{matrix} ] ; \\ {R}_{pumping}^{γ} = [ \begin{matrix}{r}_{11}^{γ} & {r}_{12}^{γ} & {r}_{1 i}^{γ} & {r}_{1 n}^{γ} \\ {r}_{21}^{γ} & & & \\ {r}_{k 1}^{γ} & & {r}_{ki}^{γ} & \\ {r}_{{S}_{2} 1}^{γ} & & & {r}_{{S}_{2} n}^{γ}\end{matrix} ] ;$$
S1-4, finally forming a water-pumping-injection single-sphere n-γ response function matrix R, which is expressed as follows:
$$R = {[ \begin{matrix}{R}_{injection}^{n} & {R}_{pumping}^{n} & {R}_{injection}^{γ} & {R}_{pumping}^{γ}\end{matrix} ]}^{T} .$$

9. The method for water-pumping-injection single-sphere neutron spectrum timing measurement according to claim 7, wherein a specific process of the S4 is as follows:
S4-1, closing the bottom valve, opening the top valve and the sprayer, continuously injecting the moderator liquid into a water injection pipe, converting the liquid into the uniformly fine mist through the sprayer, and spraying evenly inside the moderation cavity through the nozzles to form a uniformly distributed mist sedimentation effect;
S4-2, at a first time node of the set first time sequence, outputting, through the central detector, the neutrons and prompt gamma-ray pulse signals measured for the first time, converting, through the data acquisition and processing subsystem, the pulse signals into digital signals, and calculating a count value N₁ of the digital signals measured for the first time; and
S4-3, according to a preset time interval of the first time sequence, continuously recording, through the central detector, pulse signals at each of time nodes 2-S₁ in sequence, converting the pulse signals into digital signals one by one correspondingly through the data acquisition and processing subsystem, and sequentially calculating count values N₁-NS₁ of the digital signals corresponding to the respective time nodes.

10. The method for water-pumping-injection single-sphere neutron spectrum timing measurement according to claim 7, wherein a specific process of the S7 is as follows:
S7-1, closing the top valve and the sprayer, opening the bottom valve, and continuously pumping out the moderator liquid in the moderation cavity from a water pumping pipe;
S7-2, at a first time node of the set second time sequence, outputting, through the central detector, prompt gamma-ray pulse signals measured for the first time, converting, through the data acquisition and processing subsystem, the pulse signals into digital signals, and calculating a count value M₁ of the digital signals measured for the first time; and
S7-3, according to a preset time interval of the second time sequence, continuously recording, through the central detector, pulse signals at each of time nodes 2-S₂ in sequence, converting the pulse signals into digital signals one by one correspondingly through the data acquisition and processing subsystem, and sequentially calculating count values M₁-MS₂ of the digital signals corresponding to the respective time nodes.
